(19) United States
(12) Patent Application Publication
(10) Pub. No.: US 2011/0266264 A1
(43) Pub. Date: Nov. 3, 2011

(54) METHOD AND APPARATUS FOR FORMING GROOVES IN THE SURFACE OF A POLYMER LAYER

(76) Inventor: Philip Thomas Rumsby, Bladon (GB)

(21) Appl. No.: 13/143,055

(22) PCT Filed: May 14, 2009
(86) PCT No.: PCT/GB2009/001232

§ 371 Date: Jun. 30, 2011

(30) Foreign Application Priority Data
Jan. 3, 2009 (GB) 0900036.5

(51) Int. Cl. B23K 26/06

(52) U.S. Cl. 219/121.72; 219/121.67

(57) ABSTRACT

A method for the formation of grooves (74, 85) in the surface of a polymer layer substrate (36, 46, 51, 65, 73, 83) by a direct write laser vaporization process, the polymer being selected, or modified by the addition of organic or inorganic material, so that it strongly absorbs wavelengths in the range 525 nm to 535 nm, the method comprising the steps: providing a laser beam (32, 42) with a wavelength in the range 525 nm to 535 nm that has diffraction limited or substantially diffraction limited beam quality and operates either continuously, quasi-continuously or Q-switched, using an optical system (35, 45, 64, 72, 82) to focus the laser beam to a focal spot on the surface of the substrate, using a scanner (44, 63) to move the focal spot relative to an area on the substrate so the substrate surface is vaporized where it is exposed to the beam so as to form a groove with a depth that is less than the thickness of the polymer layer, controlling the scanner so as to change the position of the focal spot on the substrate whereby grooves having straight and curved portions along their length are written on the surface of the substrate, and regulating the power of the laser beam reaching the surface of the substrate so that the writing process is started and stopped whereby grooves of desired lengths are formed.

### TECHNICAL FIELD

This invention relates to a laser apparatus and method for forming grooves in the surface of a polymer substrate, particularly the high speed formation of grooves of complex shape and of controlled depth and width, eg in the manufacture of micro-electronic circuits.

### PRIOR ART

Lasers have been used for many years for the formation of grooves in substrates. An early (1977) example is given in U.S. Pat. No. 4,022,602 which describes how a continuous laser beam of wavelength 488 nm is used to form fine grooves in the surface of an absorbing glass, substrate by focusing the beam onto the substrate surface and moving the substrate with respect to the beam. Recently there has become a great interest in forming fine grooves or trenches in polymer layers for the manufacture of advanced micro-electronic circuits. US2005/0041398A1 and a publication “Unveiling the next generation in substrate technology”, Huemoeller et al, 2006 Pacific Micro-electronics Symposium describe the concept of “laser-embedded circuit technology”. In this new technology, lasers are used to directly ablate fine grooves in organic dielectric substrates. The laser patterned substrates are subsequently metalized leaving a pattern of embedded conductors after excess metal has been removed. Pulsed UV lasers have been generally used to form the grooves by a process of multi-shot ablation using either direct write or mask imaging methods. For direct write groove formation, pulsed Q-switched or mode locked solid state lasers operating at 355 nm are used whereas for mask imaging pulsed excimer gas lasers operating at 248 nm or 308 nm are used.

UV solid state lasers have relatively low operating costs but generate only low output power (eg <20 W) and have high purchase costs in terms of price per W of output power. Excimer lasers can generate several 100 W of output power and have much more modest purchase costs in terms of price per W of output power but have very high operating costs. The high cost of ownership of both laser types has raised barriers to their use as sources for incorporation into “laser embedded circuit technology” tools.

The present invention aims to overcome or reduce such problems by providing an improved laser direct write groove forming process that enables a laser having a lower cost of ownership to be used.

### SUMMARY OF INVENTION

According to a first aspect of the invention, there is provided apparatus for the formation of grooves in the surface of a polymer layer substrate using a direct write laser vaporization process, the polymer having been selected, or modified by the addition of organic or inorganic material, so that it strongly absorbs wavelengths in the range 525 nm to 535 nm, the apparatus comprising:
a. a laser that emits a beam with a wavelength in the range 525 nm to 535 nm that has diffraction limited or substantially diffraction limited beam quality and operates either continuously, quasi-continuously or Q-switched,
b. an optical system for focussing the laser beam to a focal spot on the surface of the substrate,
c. a scanner for moving the focal spot relative to an area on the substrate such that the substrate surface is vaporized where it is exposed to the beam so as to form a groove with a depth that is less than the thickness of the polymer layer,
d. a first control system for the scanner for changing the position of the focal spot on the substrate so that grooves having straight and curved portions along their length can be written on the surface of the substrate, and
e. a second control system for regulating the power of the laser beam reaching the surface of the substrate such that the writing process can be started and stopped so as to form grooves of desired lengths, the first and second control systems being arranged to form grooves having a desired depth less than the thickness of the polymer layer:

According to a second aspect of the invention, there is provided a method for the formation of grooves in the surface of a polymer layer substrate by a direct write laser vaporization process, the polymer being selected, or modified by the addition of organic or inorganic material, so that it strongly absorbs wavelengths in the range 525 nm to 535 nm, the method comprising the steps:
f. providing a laser beam with a wavelength in the range 525 nm to 535 nm that has diffraction limited or substantially diffraction limited beam quality and operates either continuously, quasi-continuously or Q-switched,
g. using an optical system to focus the laser beam to a focal spot on the surface of the substrate,
h. using a scanner to move the focal spot relative to an area on the substrate so the substrate surface is vaporized where it is exposed to the beam so as to form a groove with a depth that is less than the thickness of the polymer layer,
i. controlling the scanner so as to change the position of the focal spot on the substrate whereby grooves having straight and curved portions along their length are written on the surface of the substrate, and
j. regulating the power of the laser beam reaching the surface of the substrate so that the writing process is started and stopped whereby grooves of desired lengths are formed.

Preferred and optional features of the invention will be apparent from the following description and from the subsidiary claims of the specification.

This invention provides a direct write laser vaporization process method for the high speed formation of grooves of complex shape (ie having straight and curved portions) and controlled depth and width in the surface of a polymer layer. A key aspect of the invention is that, rather than matching the laser wavelength to the polymer material in order to optimize the process quality (as done in the prior art), a cost-effective laser source with suitable beam properties is chosen and the material of the polymer layer is selected or modified so that it strongly absorbs the wavelength of the chosen laser source. Such an approach optimizes the process efficiency and minimizes the process costs.

The method thus relies on focussing a beam from a laser source onto the surface of a polymer layer where it is strongly absorbed. The beam is moved in a defined trajectory over a finite distance on the surface and along the path of the focal spot the polymer material is vaporized creating a groove that has a depth that is less than the full depth of the polymer layer. Because the beam is strongly absorbed by the substrate, it is possible to use a CW or QCW laser to write grooves in the substrate at high speed. As the laser beam is moved quickly, dissipation of the heat generated thereby is reduced. Most of the heat is thus used to ablate the substrate and undesirable heating of other parts of the substrate is reduced. If a less strongly absorbing substrate were used, as in the prior art, a pulsed laser would be required to achieve the same degree of ablation as described above.

There are certain key requirements for the laser source for making fine grooves in a polymer layer in terms of repetition rate and beam focusability. The groove width and beam speed requirements dictate that the laser used for this direct write grooving process must operate either continuously or quasi-continuously, ie the pulses must have a repetition rate that exceeds a minimum value. In an extreme case, the groove width may be as small as 10 μm and as up to 10 laser pulses may be required to remove material to the depth required for speeds up to several metres per second, pulsed laser repetition rates exceeding several MHz are required. For wider grooves lower repetition rates are acceptable. It is generally required that the depth of the groove is substantially constant along its length and hence the laser beam repetition rate must be sufficiently high that the distance travelled by the beam over the substrate between pulses is substantially less than the groove width. In general, it is likely that repetition rates exceeding a few 100 kHz will be required.

Ideal lasers for this direct write grooving process operate either continuously (CW lasers) or operate at such a high repetition rate that they behave like CW lasers. Such high repetition rate lasers are sometimes called quasi-continuous (QCW). A particular type of QCW laser operates at very high repetition rates in the 80 to 120 MHz range. Such QCW lasers generally emit pulses with sub-nanosecond duration and are ideal for the direct writing of grooves. Lasers of the CW and QCW type are well known and readily available. Pulsed Q-switched lasers can also be used for groove formation if they can operate at sufficiently high repetition rate. So called Nd:Vanadate lasers are able to operate up to several 100 kHz and are therefore also suitable. Such lasers can thus also be described as quasi-continuous (QCW).

A second key requirement of the laser source is that the quality of the beam must be high so that it is able to be focussed to a small spot on the substrate surface to allow narrow grooves to be formed. In general, the beam should be of diffraction limited or substantially diffraction limited performance. CW, QCW or Q-switched lasers emitting beams of sufficiently high quality are well known and are readily available

A third key property of the laser source for the grooving process is its wavelength. This is chosen by consideration of both cost effectiveness and beam focusability. The most efficient and hence lowest cost per Watt solid state lasers operate in the near infra-red (IR) at wavelengths around 1.064 μm. Solid state lasers operating at shorter wavelength than this are usually based on harmonic conversion from the fundamental IR wavelength to higher harmonics. Lasers operating at around 532 nm (second harmonic) and around 355 nm (third harmonic) are well known. Higher harmonic wavelengths (eg fourth harmonic at around 266 nm) are also available but in general the power is too low to be of relevance for this grooving process. Since the harmonic conversion process has an efficiency significantly less than 100%, the power available from the shorter wavelength lasers discussed above is less than that available from the equivalent fundamental IR laser. In addition, the complexity and cost of the laser increases significantly as the wavelength is decreased so that the cost per Watt increases dramatically as wavelength reduces. Hence, from the point of view of cost and power there is an advantage in operating at longer rather than shorter wavelengths.

On the other hand, there is a significant advantage in operating at shorter rather than longer wavelength in terms of minimum focal spot size achievable on the substrate surface. The minimum focal spot size that can be realized with a given beam quality, lens focal length and beam diameter scales linearly with wavelength. If the laser beams are diffraction limited or substantially diffraction limited, and the depth of focus of the beam is held constant, then the minimum focal spot size scales as λ^{1.5,}, where λ is the laser wavelength. Hence, from the point of view of ease of achieving the narrowest groove width and maintaining longest depth of focus, there is an advantage in operating at shorter rather than longer wavelength.

In a preferred embodiment of this invention, the groove formation process is performed by a laser operating in the range 525 nm to 535 nm eg at or close to a wavelength 532 nm. Such a wavelength is generated by conversion to the second harmonic of the fundamental output from an IR solid state laser based on Nd doped Yag or Vanadate. This operating wavelength is chosen as an optimum compromise value when balancing the competing considerations of capital and operating cost per W of power on one hand and minimum focal spot size on the other.

As indicated above, a requirement for the present invention is that the laser beam must interact strongly with the polymer layer in order to vaporize it locally. In general, this means that it must be strongly absorbed by the dielectric material. Since the laser wavelength is fixed at or about 532 nm, in order to ensure adequate absorption it is necessary to use a polymer layer having a composition that gives rise to a high level of absorption at this wavelength. In general, many polymer materials are transparent in the visible region of the spectrum around 532 nm and so do not absorb sufficiently strongly. In this case, it is necessary to introduce additives to the polymer to cause it to become strongly absorbing at 532 nm. The absorbing additive material can be of organic type in which case the polymer material retains a homogeneous composition. Alternatively, the absorbing additive material may be of inorganic type. In this case such an additive is usually in the form of small inorganic particles which are supported in an organic binder. In this case, the polymer material has an inhomogeneous composition. Hence, the. present invention will often involve the use of polymers that have been modified to cause them to be highly absorbing at or close to a wavelength of 532 nm.

Another important feature is the method used to move the beam over the substrate surface. The simplest method to move the laser beam is by motion of the substrate on linear stages in two axes under a stationary lens. This method is generally slow and therefore the preferred method is to use a two axis beam scanner unit to deflect the beam rapidly in two orthogonal directions. Such scanner units are very well known and are generally used with a lens situated after the scanner. In this case, so called f-theta lenses are often used since this type of lens is designed to operate in this mode and create, as far as is possible, a focal spot of constant size and shape over a flat field. In some cases, however, it may be appropriate to use a lens situated before the scanner unit. Such an arrangement generally gives rise to a curved focal plane and in this case the use of a dynamic variable telescope situated before the lens to adjust the focal plane is required. The use of a dynamic variable telescope with an f-theta lens situated after the scanner is also possible. Such arrangements with a dynamic variable telescope are usually referred to as three axis scanners and are readily available.

The ability to rapidly control the beam power over a wide range is a key feature of the method described. It is important since, for a fixed beam speed over the substrate, the depth of groove formed varies with laser power. For the case of CW and QCW lasers, a preferred method for power control and gating on and off of the beam is by the use of an acousto-optic modulator. Such devices for use with laser beams operating at or close to 532 nm are well known and can be used to control the laser power over a wide range. For the case of high repetition rate Q-switched lasers, it is common that the gating of the pulse train and the energy per pulse and hence power can be controlled by modulating the trigger signals sent to the Q-switch. Other electro-optical based methods for controlling the laser power at the substrate can also be used.

The width of the groove formed is a function of the size of the focal spot on the substrate surface. The larger the focal spot the wider the groove. Hence, it is advantageous to be able to change the spot size. This is readily achieved by changing the size of the laser beam at the focussing lens by adjustment of the spacing of optics in a simple 2-component beam telescope placed before the lens. As the beam size at the lens is increased, so the focal spot size is reduced. It is highly advantageous to be able to change the beam size at the lens and at the same time maintain the collimation of the beam so that the substrate remains at the focal plane of the lens. This is accomplished by means of a multi-component telescope with 2 or more moving components. Such a device can be motorized to enable rapid changes of focal spot size and hence rapid changes of groove width to be made

One significant disadvantage of changing the focal spot size in order to vary the groove width is that, because of the Gaussian profile of power in the focal spot, trying to limit the groove depth to a value significantly less than the groove width is very difficult. In general, the requirement for buried conductors is that, within a particular circuit device, the depth should remain constant irrespective of conductor width. This means that the depth of the grooves created for the conductor paths must also be independent of width. This leads to a requirement for wider grooves with cross sectional profiles having regions on the groove base that are flat.

There are several methods that can be used to form such wide, flat based grooves. One of these involves sequentially forming a series of parallel grooves that are spaced sufficiently closely to each other that a wider groove is formed. Another of these involves focussing the beam to a smaller diameter spot than the width of the required groove and oscillating the spot in the direction perpendicular to the groove direction while the beam is moved along the groove trajectory. As long as the distance advanced along the groove direction by the oscillating beam in the time taken to move the spot from one side of the groove to the other is much less than the spot diameter, each area of the groove is subjected to a substantially uniform power density so creating a groove with a substantially flat base. The spot oscillation frequency needs to be high in order to achieve a uniform power distribution over the groove width and along the groove length. As an example, take the case where a laser beam is focussed by a lens with a focal length of 200 mm to a focal spot with a diameter of 0.025 mm and this spot is oscillated across the groove in order to create a groove that is 0.1 mm wide. If the beam speed along the groove is 1 m/sec and a beam overlap factor along the groove of 20% (or 5 passes per spot width) is required in order to have a uniform distribution of power, then the frequency of oscillation of the spot needs to be 100 kHz and the deflection angle is +/−0.25 mrads. Acousto-optical laser beam deflectors are readily available for use with high quality laser beams operating at around 532 nm. These are readily able to exceed the required rates and deflections. If the grooves are not straight, and such an approach is used, then two acousto-optical deflectors can be used in series to allow oscillation in a direction that is at all times perpendicular to the groove direction even when the groove changes direction. Such 2-axis acousto-optical beam deflector units are well known.

Another groove widening method uses an acousto-optical deflector of the type discussed above to create a line of closely spaced focal spots aligned perpendicularly to the beam movement direction. The focal spots are sufficiently close that they overlap to create a wider groove with a flat bottom. A 2-axis beam deflector allows the line of focal spots to be maintained perpendicular to the beam movement direction for the case of grooves that change direction.

Another method that can be used to form a groove with a flat base involves placing a diffractive optical element in the laser beam path in order to create a spot at the focus of the lens that has a special shape and has a substantially uniform power density distribution. A laser spot with a uniform power density profile is said to have a “top-hat” profile. If the laser beam quality is such that it can be focussed to a spot having a smaller diameter than the width of the required groove, then the diffractive optical element can be designed to create a spot having a size that is larger than the focal spot and matches the required groove width. The spot can be circular, square or some other appropriate shape. Moving a circular spot with “top-hat profile” over the substrate surface leads to a groove profile that is far from flat at the base as during the beam motion the centre of the groove is exposed to a total laser power that is much higher than at the groove edges. This depth non-uniformity problem can be overcome by using a square spot with the direction of movement of the spot over the surface substantially parallel to the edges of the square spot. Applying this to the method described in which grooves follow arbitrary and complex paths means that the diffractive optical element has to rotate about the laser beam axis such that the edges of the square spot are maintained substantially parallel to the beam movement direction. Such an arrangement is possible but in this case a mechanism to rotate the diffractive optical element at high speed is required. If a beam moving over the surface at a speed of 1 m/sec is used to create a groove having a 90° bend with a radius of 0.5 mm, then the diffractive optical element needs to rotate through 90° in less than 1 ms.

A preferred method is to use a static diffractive optical element that forms a substantially octagonal shaped spot. Such a method creates a groove that has a bottom profile that is inferior to a square spot moving parallel to two of its edges but is superior to that produced by a circular spot. Such a moving octagonal spot arrangement can give satisfactory results in terms of groove profile and depth uniformity whatever the groove direction but if the design of the groove trajectory can be arranged such that the predominant paths lie substantially parallel to opposing pairs of sides of the octagonal spot then improved results can be achieved.

In practice, it is often the case that the embedded conductor circuit devices that need to be created are relatively small and multiple small area identical devices are arranged in an array on a circuit board. In this case, either or both the substrate and the scanner unit are mounted on linear stages so as to allow relative motion between the scanner unit and the substrate in two orthogonal directions so that the circuit devices on the substrate can be processed in sequential steps. After one device has been completed, the relative positions of the substrate and scanner are changed by motion of the linear stages so that a new device can be processed. Operation over a large panel having multiple devices is thus in a “step and scan” mode.

If the field of the scan lens is insufficiently large to cover the whole area of a single circuit device in one operation, then the circuit groove pattern can be divided up into several separate smaller overlapping areas which can be individually processed. Such circuit sub-areas are commonly referred to as “tiles”. In this case, processing of the panel proceeds in a primary “step and scan” mode between circuit devices and also has a secondary “step and scan” mode to cover all tiles within each individual circuit device. Clearly, in such a mode of operation, great care has to be taken to ensure that the depth and width of the grooves in the overlapping boundaries between tiles remain constant. This is achieved by accurate positioning of the beam with respect to the substrate and careful control of laser power.

In practice, to increase the process rate, it is likely that several optical channels may be used in parallel. With sufficient power it is possible to split the beam from a single laser such that two or more scanners and lenses can operate in parallel and process different circuit devices on the same circuit board at the same time. After these devices have been processed in parallel, the relative positions of the substrate and scanner are changed so that further devices can be processed in parallel. Devices processed in parallel using the same laser at the same time like this are likely to have the same circuit features.

Many circuit boards using this groove based embedded conductor technology are constructed on a core layer with layers of different electrical circuits built up on opposite sides. The methods disclosed in the present invention can be readily extended to this situation to allow simultaneous processing of different circuit devices on opposite sides of the same device at the same time. In this case, separate optical assemblies consisting of a laser, laser beam modulator, laser beam shaping optics, scanner and lens are required for each of the two sides of the circuit board so that different circuit designs on opposite sides can be realized. A production laser tool for the high speed manufacture of multiple, multilayer, dual sided devices based on embedded conductor technology might well consist of two or more scanner and lens systems operating on one side of the circuit board and an identical combination of lasers and optics operating on the opposite side at the same time.

An important feature of the method described is a suitable control system that is able to co-ordinate the operation of the one or more 2-axis scanners that define the beam position and speed on the substrate surface, the linear stages that control the relative positions of the scanners and the substrate, the power modulation and triggering controls of the laser and other devices such as moving telescope components. Such control systems are commonly used in the laser marking and micro-machining industries.

### BRIEF DESCRIPTION OF DRAWINGS

The invention will now be further described, merely by way of example, with reference to the embodiments shown in the accompanying drawings, in which:

FIG. 1 is a schematic, perspective view showing how a groove is formed in the substrate surface by means of a focused laser beam;

FIG. 2 is a schematic, perspective view illustrating how a series of grooves of different shapes and lengths are formed on an area of a substrate;

FIG. 3 is a schematic diagram of one type of opto-mechanical system used for making grooves in a substrate surface;

FIG. 4 is a schematic diagram showing an alternative type of opto-mechanical system used for making grooves in a substrate surface;

FIG. 5 is a schematic, perspective view showing apparatus for making grooves on devices arranged in an array on a panel;

FIG. 6 is a schematic diagram showing an optical system that allows the width of the groove on the substrate surface to be rapidly changed;

FIG. 7 is a schematic, perspective view showing a method for forming grooves having a width greater than the focal spot diameter; and

FIG. 8 is a schematic, perspective view showing a method for using a diffractive optical element to form a wide groove.

### DETAILED DESCRIPTION OF DRAWINGS

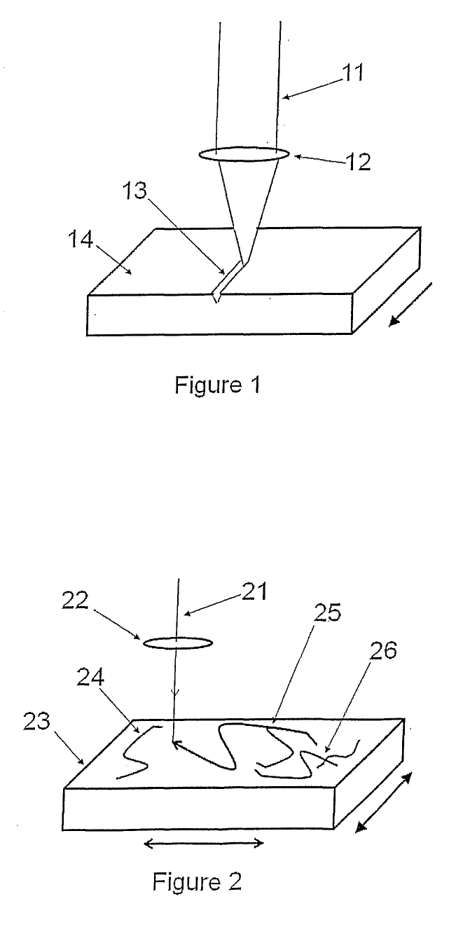

### FIG. 1

FIG. 1 shows how a beam 11 from a laser is focussed by a lens 12 in order to form a groove 13 in the top surface of a polymer substrate 14. In the case shown, the laser beam 11 is held stationary and the substrate 14 is moved on a linear stage at a speed that causes the energy deposited in the substrate in the focal spot area to be sufficient to vaporize the substrate material to form a well defined groove 13. If the power of the laser is held constant and the substrate 14 is moved at constant speed then a groove 13 of constant depth is formed that extends part way into the full depth of the substrate 14.

### FIG. 2

FIG. 2 shows the case where the laser beam 21 and focussing lens 22 are held stationary and the substrate 23 is moved in two axes by a suitable stage and control system in order to create grooves 24 of complex shape in an area on the substrate surface. The control system has the capability to co-ordinate the motion of the 2 stages in order to move in a complex path and at the same time maintain the speed of the substrate with respect to the substrate substantially constant. The figure shows the grooves 24 to be of finite length with the length being defined by the period during which the laser is operating. The figure also shows the case where grooves intersect 25 so as to provide a connection between the embedded metal that is subsequently plated into the grooves. The figure also shows the case where grooves cross 26. In both the groove intersecting and crossing cases, the laser power level, laser on time and beam speed are controlled such that the depth of the groove at the intersecting or crossing points is held substantially the same as for the remainder of the groove.

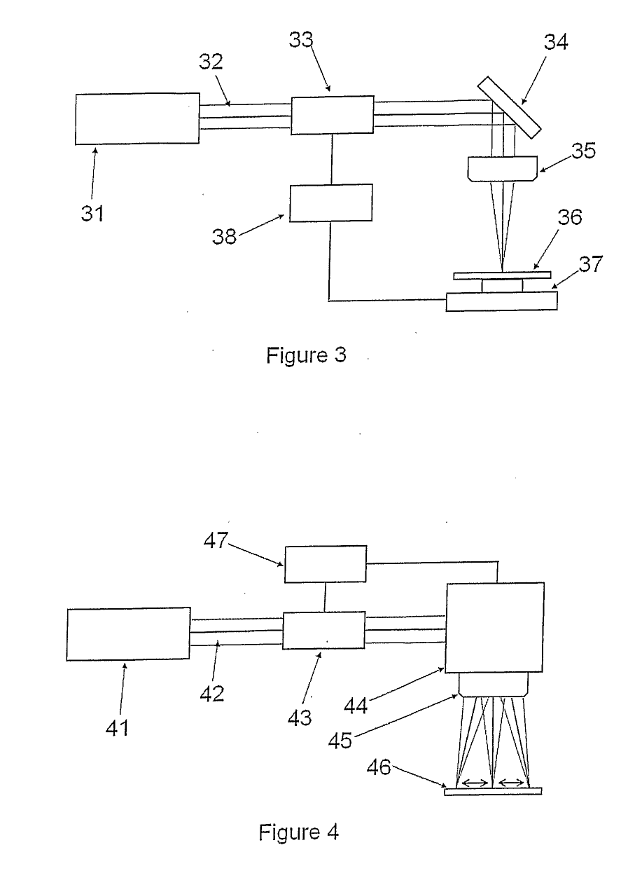

### FIG. 3

FIG. 3 shows one simple embodiment of this invention where a CW or QCW solid state laser 31 emits a beam 32 at a wavelength of or close to 532 nm. The beam 32 passes through a beam modulator unit 33 that controls the transmitted laser power level and is then reflected from a mirror 34 to pass through a lens 35 that causes the beam to be focussed on the surface of a substrate 36. The substrate 36 is mounted on a 2 axis stage system 37 driven by a controller unit 38. The controller unit 38 co-ordinates the motion of the stages in order to move the substrate 36 at the required speed in the required trajectory and also provides control signals for the modulator 33 to switch the laser 31 on and off and regulate the laser power such that grooves of the required shape, length and depth are formed.

### FIG. 4

FIG. 4 shows a preferred embodiment of this invention where a CW or QCW solid state laser 41 emits a beam 42 at a wavelength of or close to 532 nm. The beam 42 passes through a beam modulator unit 43 that controls the transmitted laser power level and is then deflected in 2 axes by a beam scanner unit 44. A lens 45 situated after the scanner unit 44 causes the beam to be focussed on the surface of a substrate 46. A controller unit 47 co-ordinates the motion of the mirrors in the scanner unit 44 in order to move the beam over the substrate surface at the required speed and in the required trajectory and also provides control signals for the modulator 43 to switch the laser 41 on and off and regulate the laser power such that grooves of the required shape, length and depth are formed.

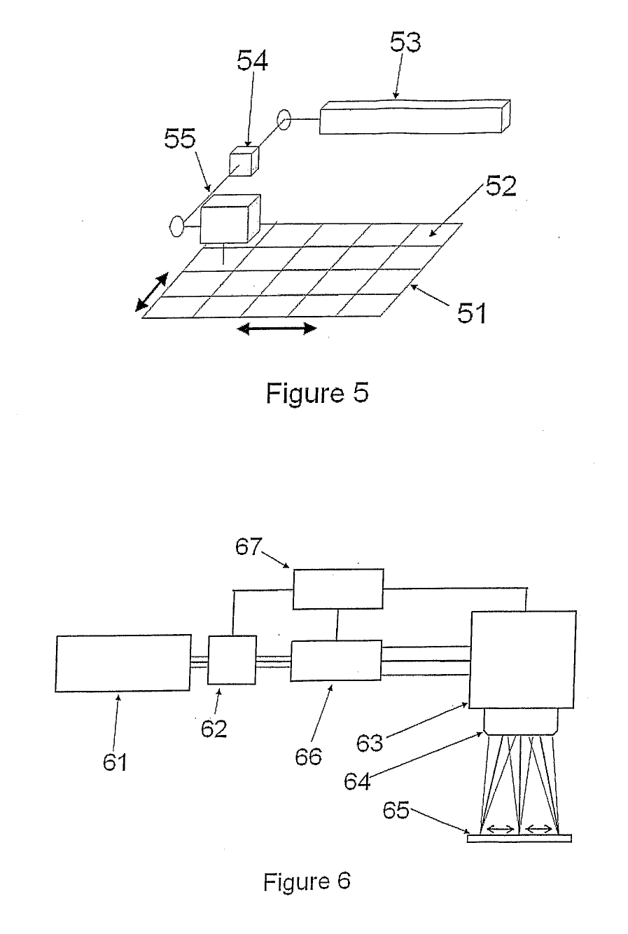

### FIG. 5

FIG. 5 shows another embodiment of the invention consisting of an apparatus that is appropriate for performing the laser grooving process on a circuit board 51 containing multiple repeating circuit devices 52 on each board 51. Laser 53 generates a beam that passes through modulator 54 to a scanner and lens unit 55. The beam is then focussed onto the substrate surface. The circuit board 51 is mounted on a chuck on a stage system that allows it to move in 2 axes over its full length and width. A control system moves the stages so that the circuit board 51 is positioned such that a device on the circuit board 51 is located under the scanner unit 55. The stages hold the circuit board 51 stationary while the scanner 55 moves the focussed laser beam over the substrate surface to define the required pattern of grooves. The stages then move the circuit board 51 to a new device 52 and the scan process is repeated. This step and scan process repeats until all devices 52 on the circuit board 51 have been processed. The figure shows the apparatus with a single scanner and lens unit 55 operating on the circuit board 51 but if the laser 53 has sufficient power division of the beam into two or more parallel channels each feeding a separate scanner unit 55 is possible. Various methods are possible to achieve relative motion between the scanner 55 and the substrate. Rather than motion of the substrate in 2 axes under a stationary scanner 55 as shown in the figure, it is possible for the substrate to remain stationary and the scanner 55 to move in 2 axes. It is also possible for the substrate to move in one axis and the scanner 55 in the orthogonal direction in a split axis arrangement.

### FIG. 6

FIG. 6 shows a further embodiment of this invention that allows variations in the groove width to be made rapidly and automatically. A CW or QCW solid state laser 61 emits a beam at a wavelength of or close to 532 nm. The beam passes through a beam modulator unit 62 that controls the transmitted laser power level. A 2 axis scanner unit 63 deflects the beam and lens 64 situated after the scanner unit causes the beam to be focussed on the surface of a substrate 65. A motorized collimating zoom telescope 66 is situated in the beam path before the scanner 63. This type of unit 66 is well known and consists of multiple lenses some of which are moveable along the optic axis of the telescope to change the component spacings. By changing the spacing of components in a defined way, the unit can be used to vary the size of the beam exiting the telescope 66 while at the same time maintaining the collimation of the beam constant. By means of this device, it is possible to vary the size of beam focal spot while maintaining the focus on the surface of the substrate 65. A controller unit 67 co-ordinates the motion of the mirrors in the scanner unit 63 in order to move the beam over the substrate surface at the required speed and in the required trajectory and also provides control signals for the modulator 62 to switch the laser 61 on and off and regulate the laser power such that grooves of the required shape, length and depth are formed. It also controls the position of the moveable lens elements in the variable collimating telescope 66 to set or change the spot size at the substrate 65.

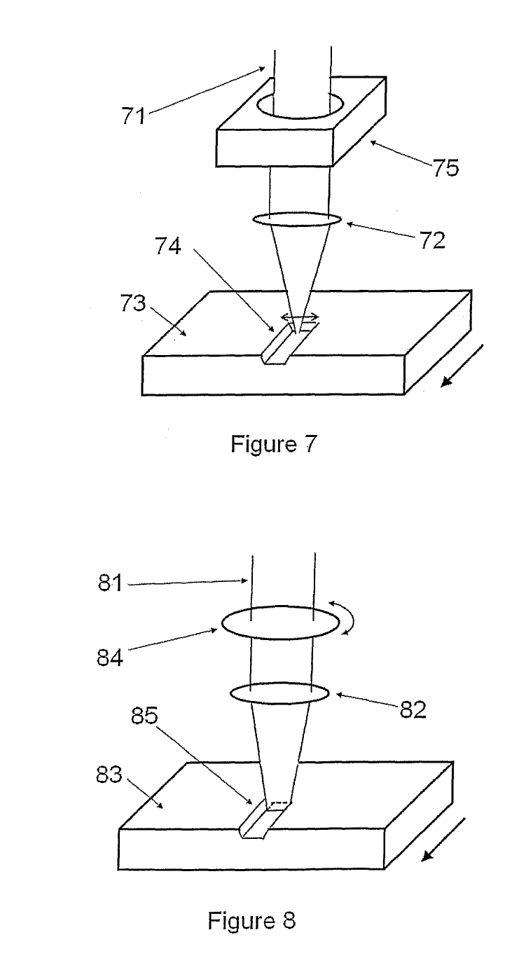

### FIG. 7

FIG. 7 shows a further embodiment of this invention and illustrates one method for forming grooves that are wider than the diameter of the laser beam focal spot and have a base that has a flat region. A laser beam 71 with a wavelength of or close to 532 nm is focussed by a lens 72 in order to form a groove 74 in the top surface of a polymer substrate 73. In the figure, the laser beam 71 is held stationary and the substrate 73 is moved on a linear stage. The groove 74 that is formed is substantially wider than the diameter of the focal spot. This is achieved by passing the beam 71 through a one axis acousto-optical beam deflector unit 75 arranged to cause the beam 71 to be angularly deflected and the focal spot to be oscillated rapidly over a distance equal to the required groove width in the direction perpendicular to the direction of motion of the substrate 73. A groove 74 with a substantially flat bottom is formed so long as the speed of travel of the substrate 73 along the groove direction is such that the distance advanced along the groove direction by the oscillating beam in the time taken to move the spot from one side of the groove 74 to the other is much less than the spot diameter. For the case where grooves 74 are not straight, then two acousto-optical deflectors 75 can be used in series to allow oscillation in a direction that is at all times perpendicular to the groove direction even when the groove 74 changes direction.

### FIG. 8

FIG. 8 shows a further embodiment of this invention and illustrates another method for forming wide grooves having a flat base. A laser beam 81 with a wavelength of or close to 532 nm is focussed by a lens 82 in order to form a groove 85 in the top surface of a polymer substrate 83. In the figure, the laser beam 81 is held stationary and the substrate 83 is moved on a linear stage. A suitable diffractive optical element 84 is placed in the beam path. In the case shown, the diffractive optical element 84 transforms the laser beam 81 at the lens focal plane into a substantially square shape with a substantially uniform power density distribution so that, so long as the substrate motion direction is parallel to two of the sides of the square spot, the groove 85 formed has a substantially flat base. In practice, grooves 85 are not always straight so that in order to maintain a flat base as the groove 85 bends, it is necessary to rotate the diffractive optical element 84 to keep the edges of the square spot parallel to the groove direction as indicated in the figure. A diffractive optical element 84 can be used to create many different shaped spots on the substrate 83. In some cases, a laser spot having a substantially octagonal shape can be advantageous.

1. Apparatus for the formation of grooves in the surface of a polymer layer substrate using a direct write laser vaporization process, the polymer having been selected, or modified by the addition of organic or inorganic material, so that it strongly absorbs wavelengths in the range 525 nm to 535 nm, the apparatus comprising:
a. a laser that emits a beam with a wavelength in the range 525 nm to 535 nm that has diffraction limited or substantially diffraction limited beam quality and operates either continuously, or quasi-continuously
b. an optical system for focussing the laser beam to a focal spot on the surface of the substrate,
c. a scanner for moving the focal spot relative to an area on the substrate such that the substrate surface is vaporized where it is exposed to the beam so as to form a groove with a depth that is less than the thickness of the polymer layer,
d. a first control system for the scanner for changing the position of the focal spot on the substrate so that grooves having straight and curved portions along their length can be written on the surface of the substrate, and
e. a second control system for regulating the power of the laser beam reaching the surface of the substrate such that the writing process can be started and stopped so as to form grooves of desired lengths, the first and second control systems being arranged to form grooves having a desired depth less than the thickness of the polymer layer.

2. Apparatus as claimed in claim 1 in which the speed of movement of the laser focal spot on the substrate surface is controllable such that grooves can be written with a desired depth at any point along their length.

3. Apparatus as claimed in claim 1 in which the laser power in the focal spot at the substrate and/or the size of the focal spot on the substrate surface is controllable such that grooves can be written with a desired depth at any point along their length.

4. Apparatus as claimed in claim 1 in which the optical system comprises a diffractive optical element to form a spot on the substrate surface having a substantially “top hat” type power density profile so that a groove with a well defined width and having a substantially flat base can be formed.

5. Apparatus as claimed in claim 4 in which the diffractive optical element is arranged to form a substantially octagonal spot on the substrate surface.

6. Apparatus as claimed in claim 4 in which the diffractive optical element is arranged to form a substantially square spot on the substrate surface and is rotatable as the beam moves over the substrate surface whereby opposing edges of the spot can be maintained substantially parallel to the length of the groove being formed.

7. Apparatus as claimed in claim 1 in which the optical system comprises a high speed beam deflector unit for oscillating the focal spot on the substrate surface over a short distance in a direction substantially perpendicular to the length of the groove whereby a groove having a defined width and a substantially flat base can be formed.

8. Apparatus as claimed in claim 1 in which the optical system comprises a beam spreader unit to faun a line of closely spaced focal spots on the substrate surface the line being being substantially perpendicular to the length of the groove.

9. A method for the formation of grooves in the surface of a polymer layer substrate by a direct write laser vaporization process, the polymer being selected, or modified by the addition of organic or inorganic material, so that it strongly absorbs wavelengths in the range 525 nm to 535 nm, the method comprising the steps:
a. providing a laser beam with a wavelength in the range 525 nm to 535 nm that has diffraction limited or substantially diffraction limited beam quality and operates either continuously or quasi-continuously,
b. using an optical system to focus the laser beam to a focal spot on the surface of the substrate,
c. using a scanner to move the focal spot relative to an area on the substrate so the substrate surface is vaporized where it is exposed to the beam so as to form a groove with a depth that is less than the thickness of the polymer layer,
d. controlling the scanner so as to change the position of the focal spot on the substrate whereby grooves having straight and curved portions along their length are written on the surface of the substrate, and
e. regulating the power of the laser beam reaching the surface of the substrate so that the writing process is started and stopped whereby grooves of desired lengths are formed.

10. A method as in any claim 8 in which a defined area of the substrate contains a multiplicity of grooves having different shapes along their lengths and all these grooves are formed in a single process step with the substrate held stationary and the motion of the beam over the substrate within the defined area is caused only by the 2 axis scanner system

11. A method as claimed in claim 8 in which the substrate and/or the scanner are mounted on linear stages to allow relative motion between the scanner and the substrate in two orthogonal directions so that a multiplicity of defined areas on the substrate can be processed in sequential steps.

12. A method as claimed in claim 10 in which a defined area processed in a single scanning operation includes the full area of an electronic circuit device on the substrate.

13. A method as claimed in claim 10 in which the defined area processed in a single scanning operation is less than the full area of an electronic circuit device on the substrate and the required groove pattern comprises two or more overlapping sub-areas which are each individually laser patterned using the 2 axis scanner and the relative positions of the substrate and scanner are changed after each sub-area has been processed in order to form the required groove pattern over the whole of the device.

14. A method as claimed in claim 9 in which a defined area of the substrate contains a multiplicity of grooves of substantially similar depth wherein some of the grooves cross or join each other, the speed of relative motion between the laser beam and the substrate and/or the laser power being controlled such that each of the grooves has substantially the same depth including the points at which they cross or join.

15. A method as claimed in claim 9 in which the width of the grooves formed is in the range 0.01 to 0.1 mm.

16. A method as claimed in claim 14 in which the depth of the grooves formed is in the range 0.01 to 0.03 mm.
